(19) United States
(12) Patent Application Publication
(10) Pub. No.: US 2008/0203694 A1
(43) Pub. Date: Aug. 28, 2008

(54) Vehicle

(76) Inventors: Andreas Gartner, Bremen (DE); Jens Vortmeyer, Preussisch Oldendorf (DE); Bernd Grannemann, Espelkamp (DE); Mauro Zanella, Dielingen (DE); Metin Ersoy, Walluf (DE)

Correspondence Address: MCGLEW & TUTTLE, PC, P.O. BOX 9227, SCARBOROUGH STATION, SCARBOROUGH, NY, 10510-9227, US

(21) Appl. No.: 12/067,330

(22) PCT Filed: Sep. 18, 2006
(86) PCT No.: PCT/DE06/01650

§ 371 Date: Mar. 19, 2008

(51) Int. Cl. B60G 17/027; G06F 19/00

(52) U.S. Cl. 280/124.162; 280/124.166; 701/37

(57) ABSTRACT

Vehicle with a vehicle body (7); at least two wheels (3, 4), which are connected to the vehicle body (7) and are movable in relation thereto; a stabilizer (10), which has two legs (11, 12) connected mechanically to one another via a torsion spring (13); two actuators (16, 17), via which the legs (11, 12) are coupled with the wheels (3, 4); and a control means (21), by means of which the coupling characteristic of the actuators (16, 17) can be varied, wherein an additional spring (8, 9) each is led around each of the actuators (16, 17) on the outside, and wherein the legs (11, 12) are additionally connected to the wheels (3, 4) via the additional springs (8, 9).

### CROSS REFERENCE TO RELATED APPLICATIONS

This application is a United States National Phase application of International Application PCT/DE 2006/001650 and claims the benefit of priority under 35 U.S.C. § 119 of German Application DE 10 2005 045 177.2 filed Sep 21, 2005, the entire contents of which are incorporated herein by reference.

### FIELD OF THE INVENTION

The present invention pertains to a vehicle with a vehicle body; at least two wheels, which are connected to the vehicle body and are movable in relation thereto; a stabilizer, which has two legs, which are mechanically connected to one another via a torsion spring and via which the legs are coupled with the wheels; and a control means, by means of which the coupling characteristic of the actuators can be varied.

### BACKGROUND OF THE INVENTION

Stabilizers are known from the state of the art and are often subject to the drawback that they have permanently preset spring rates and therefore cannot be adapted to different general conditions, which has a disadvantageous effect on comfort. Stabilizers with controllable actuators, which can vary the characteristics of the stabilizer, were created for this reason.

DE 101 34 715 A1 discloses a device for the roll support of vehicles, in which a coupling yoke comprising a torsionally rigid carrier extending approximately at right angles to the longitudinal axis of the vehicle with cantilevers arranged at the ends of the carrier connects two wheels to one another. A spring-absorber unit each, which has a cylinder housing, in which a piston is guided displaceably, is arranged between the cantilevers and the wheels. The piston divides the interior space of the cylinder housing into two chambers, in which a spring each is arranged, so that the piston must work against the spring force of at least one of the two springs during a motion of the piston in the cylinder housing. Overflow valves, which can be closed by valves, are provided in the piston in order to hydraulically connect the two chambers in the cylinder housing to one another.

This subject is not comparable to a rotation stabilizer, because the carrier arranged between the two cantilevers is torsionally rigid. Furthermore, the springs must be relatively large in order to guarantee roll stabilization, so that the spring-absorber unit as a whole is very large as well. Such an arrangement is therefore rather unsuitable for smaller vehicles, e.g., passenger cars, because of space problems, and can be used preferably in the area of utility vehicles, e.g., trucks, where comparably much space is available for the wheel suspension.

EP 0 829 383 A2 discloses a stabilizer for a vehicle, which has a torsion spring arranged between two legs, where a first of the legs is connected via a rocker pendulum to a first control arm and the second leg is connected via a hydraulic actuator to a second control arm. The hydraulic actuator has a cylinder, which is connected to the second control arm and in which a piston connected to the second leg is guided displaceably. The piston divides the interior space of the cylinder into two hydraulic chambers, a first of the hydraulic chambers being joined by a pneumatic spring arranged in the cylinder. To compensate the action of the pneumatic spring, an additional spring is arranged in the second hydraulic chamber. A controllable valve is provided in the piston in order to hydraulically connect the two hydraulic chambers to one another or to hydraulically separate them from one another. When the valve is closed, the spring rate of the stabilizer is determined by the spring rate of the torsion spring alone; when the valve is opened, the piston can move within the cylinder, so that the spring rate of the stabilizer is lower than the spring rate of the torsion spring.

EP 0 270 327 A1 shows a stabilizer for a vehicle, which has two legs and a torsion spring arranged between these, wherein a first of the legs is connected via a rocker pendulum to a first of the wheels of the vehicle and the second leg is connected via a controllable hydraulic absorber as well as via a lower suspension arm to a second wheel of the vehicle. The hydraulic absorber has a cylinder connected to the suspension arm and a piston, which is guided displaceably in same and is connected via a piston rod to the stabilizer. The piston divides the interior space of the cylinder into two hydraulic chambers, which are connected to a hydraulic control device. Motion of the piston in relation to the cylinder can be blocked or released by means of the control device, and the piston is pressed in mutually opposite directions by means of a pair of springs, which are arranged in the hydraulic chambers. The spring rate of the stabilizer is determined in the blocked state by the spring rate of the torsion spring. If, by contrast, the piston is released, it can move in the cylinder, which leads to a spring rate for the stabilizer that is lower than the spring rate of the torsion spring. Furthermore, it is possible to provide a control cylinder at each end of the stabilizer.

The two prestressed springs are used to self-center the piston, a torsional torque of the stabilizer not acting on the lower arm in the extensible state of the control cylinder. These springs are correspondingly relatively small and cannot offer any appreciable resistance, if any, to the rolling motions of the vehicle.

### SUMMARY OF THE INVENTION

The object of the present invention is to perfect a vehicle of the type described in the introduction such that the stabilizer can assume at least two different spring rates and makes do at the same time with a smaller space requirement.

A vehicle according to the present invention, especially a motor vehicle, has a vehicle body; at least two wheels, which are connected to the vehicle body and are movable in relation thereto; a stabilizer, which comprises two legs connected to one another mechanically via a torsion spring; two actuators, via which the legs are coupled with the wheels; and a control means, by means of which the coupling characteristic of the actuators can be varied, where one additional spring is led around each of the actuators on the outside, and wherein the legs are additionally connected to the wheels via additional springs.

The additional springs can have a sufficient size in the vehicle according to the present invention to assume roll stabilization of the vehicle together with the torsion spring. Since the additional springs are led, moreover, around the actuators on the outside, the actuators can be made relatively small, so that, on the whole, space can be saved compared to systems in which the additional springs would be integrated within the actuators, which would thus inevitably have to be made larger than the additional springs. Furthermore, an actuator and a spring are provided at each leg, so that the system can center itself without two springs being necessary for this in each actuator. Yet, it is possible, especially for compensation or centering purposes, to additionally provide in each actuator one or more springs, which make, however, no or only a small contribution to the roll stabilization because of their small size. Since two actuators are provided, the maximum stroke per actuator can be additionally reduced, preferably by about half, which makes possible a smaller overall height for the actuators compared to conventional systems, in which only one actuator is provided per stabilizer. The solution according to the present invention thus makes possible a compact design of a stabilizer, whose spring rate can be varied by means of the control means.

The actuators can be actuated mechanically, electrically or pneumatically. However, the actuators are preferably actuated hydraulically and are hydraulically connected to the control means. The controls means may have at least one or two valve blocks, which are connected to the actuators and by means of which the hydraulic connection of the actuators is carried out. According to a first variant, a single valve block is connected hydraulically to both actuators, whereas each actuator is hydraulically connected to a valve block each according to a second variant. The valve block or valve blocks can be switched especially electrically and are preferably connected to an electronic control unit. Each of the valve blocks can have for this purpose an electrical interface, which makes possible an electrical connection, e.g., by means of a cable and/or plug, to the electronic control. A valve block shall be defined here especially as an array of at least one or more hydraulic valves, which are connected hydraulically to the respective actuator or to the actuators and can hydraulically affect the absorbing and/or force coupling characteristics of the actuator or actuators. The actuators are preferably designed as hydraulic absorbers, especially as hydraulic linear absorbers.

The actuators can be preferably switched into at least two states, the respective actuator forming a rigid connection between the respective leg and the respective wheel in a first, blocked state. The additional springs cannot be actuated in this case, so that the spring rate of the stabilizer is determined by the spring rate of the torsion spring alone. The first state is also called the “hard” stage of the stabilizer. In a second, unblocked state of the actuators, each actuator makes possible a relative motion between the respective leg and the respective wheel via the intermediary of the additional spring, so that the overall spring rate of the stabilizer is reduced by the additional springs. Thus, the stabilizer has a lower spring rate in the unblocked state than in the blocked state, and this arises especially from the series connection of the two additional springs with the torsion spring. The second state is therefore also called the “soft” stage of the stabilizer. The actuators preferably do not oppose the rolling motion of the vehicle with any force or they oppose it with a negligible force only. Furthermore, the additional springs may have a lower spring rate each than the torsion spring, and the overall spring rate of the stabilizer is determined in the unblocked state, according to a preferred variant of the present invention, by the additional springs alone or essentially by the additional springs. As an alternative or in addition, it is possible for the actuators to act as absorbers in the unblocked state or in a third state and to absorb the rolling motions of the vehicle, so that both legs or at least one of the legs are coupled with the respective wheel due to a parallel connection of the absorber and the additional spring. Independently herefrom, each of the wheels is preferably additionally connected to the vehicle body and is especially mounted on same in a spring-mounted manner, via a shock absorber and/or a vehicle spring.

The blocked state can be switched on and off especially by means of the control means or by means of the valve block or valve blocks. the switched-off blocked state preferably corresponding to the unblocked state, which embodies a fail-safe function.

The stabilizer, especially the torsion spring, is preferably mounted rotatably on the vehicle body via at least one, preferably via two stabilizer bearings. Furthermore, a control arm, via which the respective wheel is mounted especially pivotably on the vehicle body, may be inserted between each of the wheels and the respective actuator as well as the respective additional spring. The legs are coupled with the wheels in this case at least indirectly via the actuators and the additional springs via the intermediary of the control arms. As an alternative, the actuators and the additional springs may, however, also act directly on the wheel carrier of the respective wheel.

According to a variant of the present invention, it is possible for the vehicle according to the present invention to have at least a third wheel and a fourth wheel, which are connected to the vehicle body and are movable in relation thereto. These wheels may also be connected to one another via a stabilizer, two actuators and two additional springs in the same manner as the above-mentioned two wheels. Furthermore, this stabilizer, these actuators and these additional springs can be varied in the same manner as this was described above for the other stabilizers, the other actuators and the other additional springs.

The stabilizer arrangement according to the present invention with a comfortable “soft” stage and with an additional stage, which can be switched and/or controlled, has especially the following features:
a) A standard stabilizer, two actuators designed as pendulum rockers, and a hydraulic valve block.
b) The valve block contains a mechanical or electronic control for on/off design or for a controllable design.
c) The actuator components are identical parts for the controlled and uncontrolled design. A spring led around the actuator on the outside corresponds to the soft stage of the stabilizer and is not prestressed or is pressed very slightly.
d) The actuators are arranged on each side of the stabilizer (two pieces per axle) in order to minimize the overall length. In addition, the spring is placed around the actuator on the outside in order to minimize the space needed for the installation.
e) The actuator shortens during actuation, which likewise has a favorable effect on the space needed for installation.

In particular, the following advantages can be gained with the solution according to the present invention:
Uncoupling of the rolling spring mounting and lifting spring mounting.
Increase in comfort during straight travel and at low lateral accelerations due to the spring rate being switched over.
Safety due to a 50/50 stabilizer as a mechanical fail-safe solution. The coordination of the soft and/or hard stage takes place in connection with the front axle and the rear axle and makes possible the basic coordination of self-steering properties of the vehicle in the different operating states of the system (incl. fail-safe) by selecting the characteristics of the force elements.
Increased dynamics (adjustment dynamics) of the system compared to electromechanical systems.
It requires little or no additional energy.

The various features of novelty which characterize the invention are pointed out with particularity in the claims annexed to and forming a part of this disclosure. For a better understanding of the invention, its operative advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a schematic view of a first embodiment of the vehicle according to the present invention;

FIG. 2 shows a schematic view of a second embodiment of the vehicle according to the present invention;

FIG. 3 is an illustration of a graph, in which the stabilizer torque is plotted over the twist angle of the stabilizer with uncontrolled actuators;

FIG. 4 is an illustration of a graph, in which the stabilizer torque is plotted over the twist angle of the stabilizer with a controlled actuator;

FIG. 5 is an illustrating of a graph, in which the absorption torque is plotted over the velocity of twisting of the stabilizer; and

FIG. 6 is a schematic sectional view of one of the actuators according to FIG. 1.

### DESCRIPTION OF THE PREFERRED EMBODIMENTS

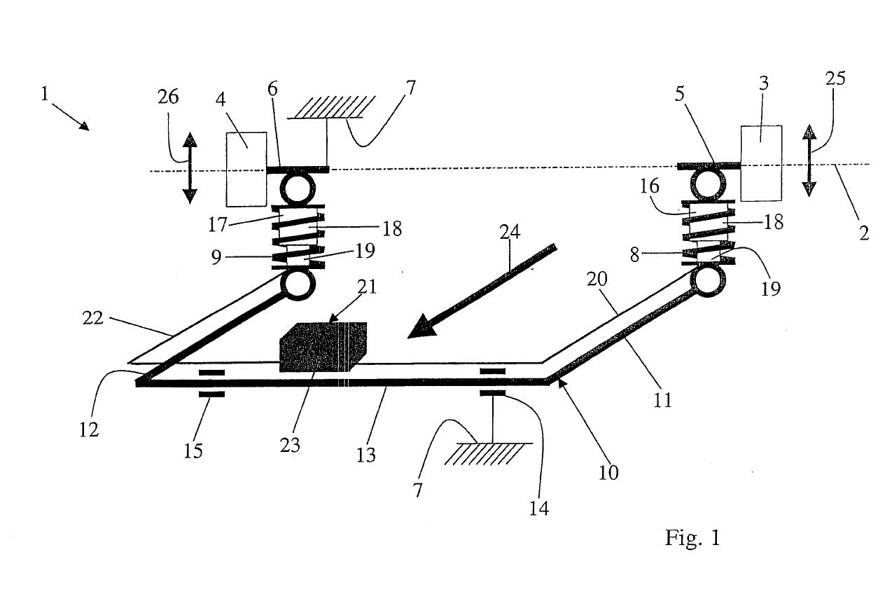

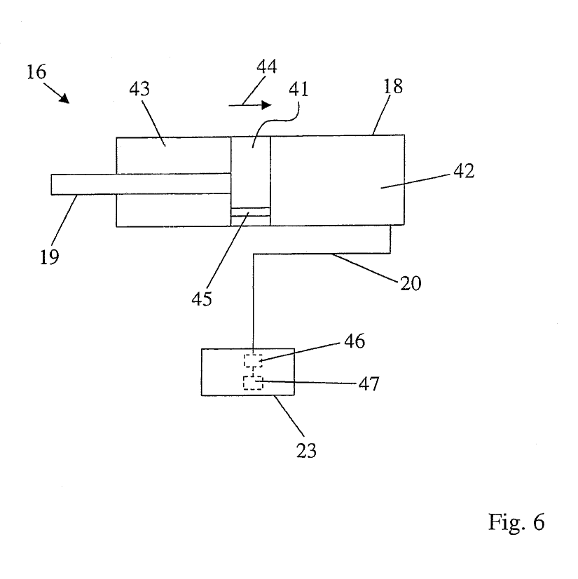

Referring to the drawings in particular, FIG. 1 shows a schematic partial view of a vehicle 1, which has a front axle 2 with a left wheel 3 and with a right wheel 4, the two wheels 3, 4 being mounted on a vehicle body 7 movably and spring-mounted via a wheel suspension 5 and 6, respectively. An additional spring 8 is connected to the left wheel 3 and to the wheel suspension 5, and an additional spring 9 is connected to the right wheel 4 and to the wheel suspension 6. The springs 8 and 9 are connected, furthermore, to a stabilizer 10, which has two legs 11 and 12 and a torsion spring 13 arranged between these. The two legs 11 and 12, which are bent in relation to the torsion spring 13, are connected to the ends of the torsion spring 13, which is mounted rotatably about its longitudinal axis at the vehicle body 7 via two stabilizer bearings 14 and 15, in such a way that the said legs rotate in unison. The leg 11 is thus connected to the left wheel 3 via the intermediary of the additional spring 8, whereas the leg 12 is connected to the right wheel 4 via the intermediary of the additional spring 9. Furthermore, the leg 11 is connected to the left wheel 3 and to the wheel suspension 5 via an actuator 16, and the leg 12 is connected to the right wheel 4 and to the wheel suspension 6 via an actuator 17. The hydraulic actuators 16 and 17 have a cylinder 18 and a piston 41 guided displaceably in same each (see FIG. 6), which piston is connected to a piston rod 19, which protrudes from the respective cylinder 18. The piston rod 19 of the actuator 16 is connected here to the leg 11, whereas cylinder 18 of the actuator 16 is connected to the left wheel 3 and to the wheel suspension 5. Furthermore, the piston rod 19 of the actuators 17 is connected to the leg 12, whereas cylinder 18 of the actuator 17 is connected to the right wheel 4 and to the wheel suspension 6.

The actuator 16 is connected via a hydraulic actuating line 20 to a control means 21, which is connected, furthermore, to the actuator 17 via a hydraulic actuating line 22. The control means 21 comprises a hydraulic valve block 23, which is arranged centrally.

If the actuators 16 and 17 are blocked, a relative motion of the piston rod 19 and the cylinder 18 of the respective actuator is no longer possible, so that the additional springs 8 and 9 are bridged over. The spring rate of the stabilizer 10 is determined in this case by the spring rate of the torsion spring 13 and corresponds to same, so that the stabilizer 10 has a “hard” characteristic.

In an unblocked state of the actuators 16 and 17, the piston rods 19 are displaceable relative to the respective cylinders 18, so that the additional springs 8 and 9 reduce the overall rigidity of the stabilizer 10. The stabilizer 10 has a “soft” characteristic in this case. It is possible by means of the control 21 and the valve block 23 to switch the actuators 16 and 17 from the blocked state into the unblocked state and vice versa.

Arrow 24 symbolizes the direction of travel or the longitudinal axis of the vehicle 1. The torsion spring 13 extends at right angles to the direction of travel, whereas the legs 11 and 12 extend approximately in parallel to the direction of travel. Furthermore, arrow 25 symbolizes the inward deflection and rebound of the left wheel 3, whereas arrow 26 symbolizes the inward deflection and rebound of the right wheel 4. The stabilizer 10 exerts its action only when the inward deflections 25 and 26 are different. Actuation or stressing of the torsion spring 13 and/or of the additional springs 8 and 9 takes place in this case. However, if the two wheels 3 and 4 have the same inward deflection and rebound, the stabilizer 10 rotates in the stabilizer bearings 14 and 15 only, without one of the springs 8, 9, 13 being stressed.

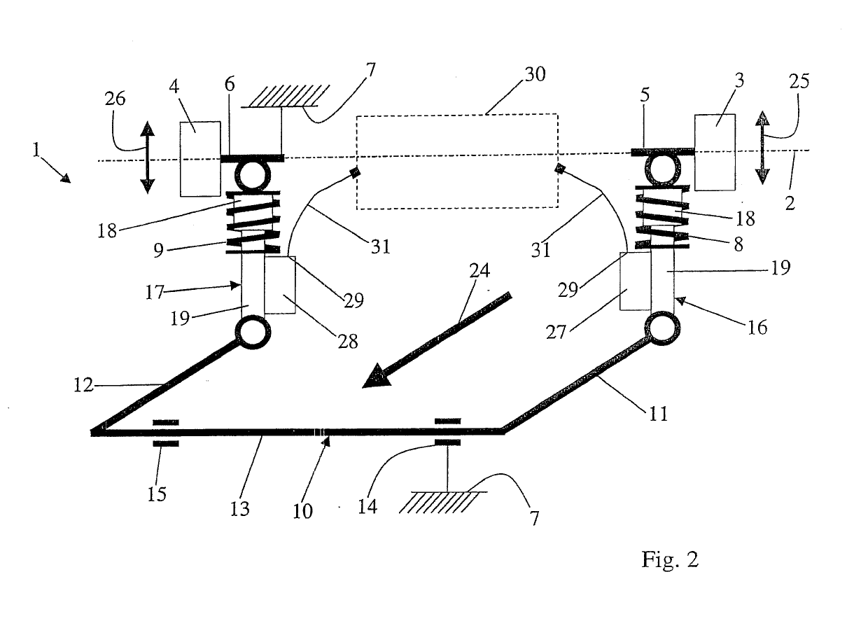

FIG. 2 shows a schematic view of a second embodiment of the vehicle according to the present invention, where similar and identical features are designated by the same reference numbers as in the first embodiment. The mechanical design of the second embodiment essentially agrees to the mechanical design of the first embodiment, and only the hydraulic connection of the actuators 16 and 17 is different. According to the second embodiment, the control means 21 has two valve blocks 27 and 28, valve block 27 being fastened to the actuator 16 and valve block 28 to the actuator 17. The valve blocks 27 and 28 are fastened to the piston rods 19 of the respective actuators 16, 17, so that the piston rods 19 can be made longer according to the second embodiment than the piston rods of the first embodiment. Furthermore, the valve block 27 is hydraulically connected to the actuator 16, whereas valve block 28 is hydraulically connected to actuator 17. Actuator 16 can be controlled by the valve block 27, especially switched into the blocked state and/or into the unblocked state, the actuator 17 being able to be controlled by the valve block 28 in a corresponding manner. The valve blocks 27 and 28 can be switched electrically and have an electrical interface 29 each, via which the respective valve block 27, 28 is connected electrically to an electronic control 30 via a cable 31.

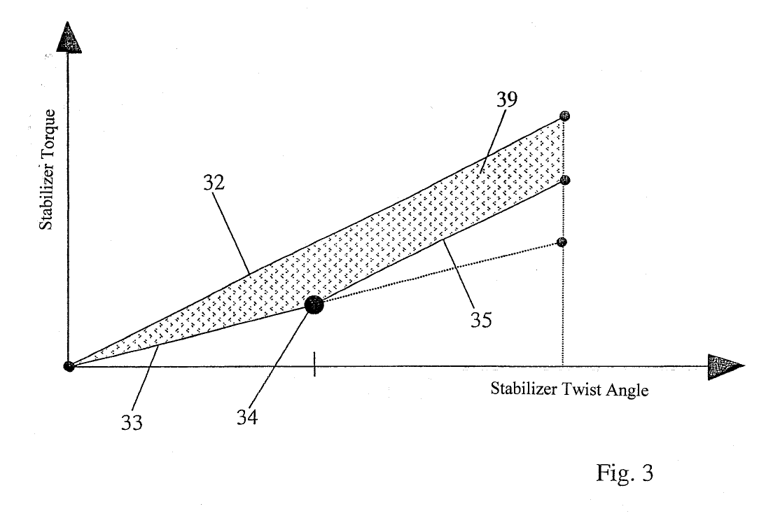

FIG. 3 shows a characteristic of the stabilizer 10, where the stabilizer torque is plotted over the twist angle of the stabilizer. Curve 32 represents here the blocked state of the actuators 16 and 17, whereas curve 33 represents the unblocked state of the actuators 16 and 17. A maximum or minimum stroke of the actuators is reached at point 34, the piston striking the cylinder (possibly via the intermediary of a buffer), e.g., in each actuator, so that further rotation of the stabilizer in the same direction corresponds to a rigid coupling in the blocked state. Therefore, curve 33 passes over at point 34 into a section 35 that extends in parallel to curve 32. Point 34 can be set by dimensioning the actuators 16 and 17 accordingly. The characteristic shown in FIG. 3 corresponds to an uncontrolled system, where only switching to and fro between the blocked and unblocked states of the actuators 16, 17 can take place. The range 39 between the two curves 32 and 33 characterizes the gain in comfort.

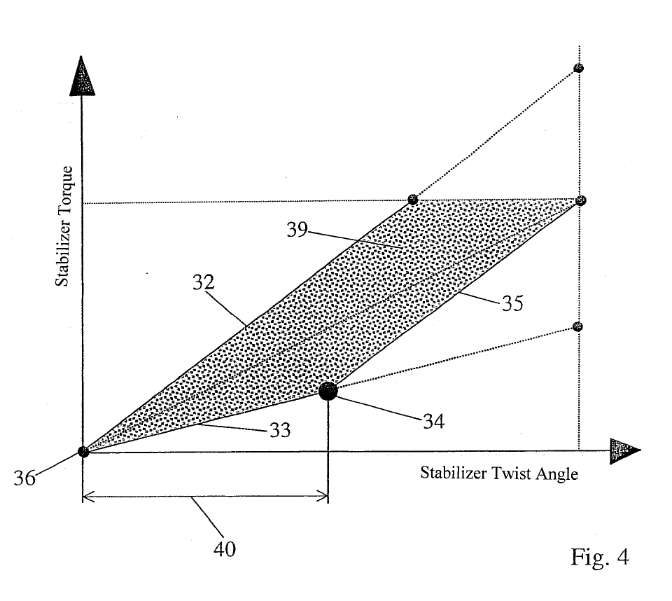

FIG. 4 shows a characteristic of stabilizer 10, where the stabilizer torque is plotted over the twist angle of the stabilizer. Contrary to FIG. 3, the actuators 16 and 17 according to FIG. 4 are controlled by the control means 21 or the electrical control 30. Curve 32 is identical to curve 32 from FIG. 3 and corresponds to the blocked state of the actuators 16 and 17. Point 34 can, by contrast, be controlled and can be displaced along curve 33, or the distance 40 between the origin 36 and the value of the twist angle of point 34 can be varied. Curve 33 between the origin 36 and point 34 is at first identical to curve 33 according to FIG. 3. However, since the range of adjustment range switchover point 34 can now be varied by the control means 21, curve 33 can assume different shapes beginning from point 34 in the direction of increasing stabilizer twist angles. A controllable roll absorption is thus achieved for the vehicle axle 2, and a so-called “skyhook algorithm” can be used to control the degree of freedom rolling. Range 39 also represents the range of adjustment in this case.

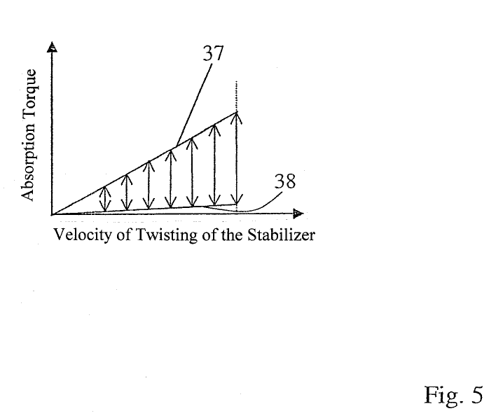

FIG. 5 shows a characteristic of the stabilizer 10, where the absorption torque of the stabilizer is plotted over the velocity of twisting of the stabilizer. Curve 37 describes a strong absorption of the actuators, whereas curve 38 represents weak absorption of the actuators. Absorption means in this case that the actuators are designed as hydraulic absorbers, whose absorption characteristic can be controlled by means of the control means 21. Curves 37 and 38 represent boundary lines of absorption, and intermediate positions can also be controlled in an anticipatory manner.

FIG. 6 shows a schematic sectional view of the actuator 16 according to FIG. 1, where the interior space of the cylinder 18 is divided by the piston 41 into two hydraulic chambers 42 and 43, which are hydraulically connected to one another via a bypass 45 provided in the piston 41. Furthermore, the hydraulic chamber 42 is hydraulically connected to the valve block 23 via the hydraulic line 20. Piston 41 is guided displaceably in cylinder 18 and can move in the direction of arrow 44 and in the opposite direction of this arrow in the unblocked state, while hydraulic fluid is exchanged via the bypass 45 between the two chambers 42 and 43. Furthermore, hydraulic fluid is transported via the line 20 to the valve block 23 or is removed from same, in which a switchable valve 46 and a hydraulic reservoir 47 are provided, which can absorb and release the differential fluid (differential oil) in the opened state of the valve 46. Line 20 is connected to the reservoir 47 via the intermediary of valve 46. By contrast, valve 46 is closed in the blocked state, so that no differential fluid can be transported, as a result of which motion of the piston 41 is blocked. Even though not shown explicitly, the actuator 17 has a design corresponding to that of actuator 16.

While specific embodiments of the invention have been shown and described in detailed to illustrate the application of the principles of the invention, it will be understood that the invention may be embodied otherwise without departing from such principles.

1-8. (canceled)

9. A vehicle, comprising:
a vehicle body;
two wheels connected to said vehicle body, each wheel being mounted for movement such that each wheel is movable relative to said vehicle body;
a torsion spring;
a stabilizer having two legs, one leg being mechanically connected to another leg via said torsion spring;
two actuators;
a plurality of additional springs, each spring surrounding one of said actuators, each leg being connected to one of said wheels via one of said additional springs and one of said actuators; and
a control means for varying coupling characteristics of said actuators.

10. A vehicle in accordance with claim 1, wherein said actuators are hydraulically connected to said control means, said actuators being actuated hydraulically via said control means.

11. A vehicle in accordance with claim 10, wherein said control means has a hydraulic valve block, which is hydraulically connected to said two actuators.

12. A vehicle in accordance with claim 10, wherein said control means has two valve blocks, each valve block being hydraulically connected to one of said actuators.

13. A vehicle in accordance with claim 11, wherein said valve block is connected to an electrical control device, said valve block being electrically controlled via said electrical control device.

14. A vehicle in accordance with claim 12, wherein said valve blocks are connected to an electrical control device, said valve blocks being electrically controlled via said electrical control device.

15. A vehicle in accordance with claim 1, wherein each actuator comprises a hydraulic absorber.

16. A vehicle in accordance with claim 15, wherein each absorber has a cylinder and a piston, said piston being guided displaceably within said cylinder, said cylinder defining an interior space, said piston dividing said interior space of said cylinder into two hydraulic chambers filled with hydraulic fluid, said piston being connected to a piston rod protruding from said cylinder.

17. A vehicle in accordance with claim 1, wherein each wheel is additionally spring-mounted on said vehicle body.

18. A vehicle, comprising:
a vehicle body;
a plurality of wheels, each wheel being connected to said vehicle body, each wheel being mounted for movement such that each wheel is movable relative to said vehicle body;
a torsion spring;
a stabilizer having two legs, one leg being connected to another leg via said torsion spring;
a plurality of actuators;
a plurality of additional springs, each spring surrounding at least a portion of one of said actuators, each leg being connected to one of said wheels via one of said additional springs and one of said actuators; and
a control means for switching said actuators from a blocked state to an unblocked state such that at least one of said legs is movable relative to one of said wheels when at least one of said actuators is in said unblocked state, wherein at least one of said actuators forms a rigid connection between one of said legs and one of said wheels when at least one of said actuators is in said blocked state.

19. A vehicle in accordance with claim 18, wherein said actuators are hydraulically connected to said control means, said actuators being actuated hydraulically via said control means.

20. A vehicle in accordance with claim 19, wherein said control means has a hydraulic valve block, which is hydraulically connected to said two actuators.

21. A vehicle in accordance with claim 19, wherein said control means has two valve blocks, each valve block being hydraulically connected to one of said actuators.

22. A vehicle in accordance with claim 20, wherein said valve block is connected to an electrical control device, said valve block being electrically controlled via said electrical control device.

23. A vehicle in accordance with claim 21, wherein said valve blocks are connected to an electrical control device, said valve blocks being electrically controlled via said electrical control device.

24. A vehicle in accordance with claim 18, wherein each actuator comprises a hydraulic absorber.

25. A vehicle in accordance with claim 24, wherein each absorber has a cylinder and a piston, said piston being moveable within said cylinder, said cylinder defining an interior space, said piston dividing said interior space of said cylinder into two hydraulic chambers filled with hydraulic fluid, said piston being connected to a piston rod protruding from said cylinder.

26. A vehicle in accordance with claim 18, wherein each wheel is spring-mounted on said vehicle body.

27. A vehicle, comprising:
a vehicle body;
a first wheel connected to said vehicle body, said first wheel being mounted for movement such that said first wheel is movable relative to said vehicle body;
a second wheel connected to said vehicle body, said second wheel being mounted for movement such that said second wheel is movable relative to said vehicle body;
a torsion spring;
a stabilizer having a first leg portion and a second leg portion, said first leg portion being connected to said second leg portion via said torsion spring;
a first actuator;
a second actuator;
a first additional spring surrounding said first actuator such that at least a portion of said first actuator is located within said first additional spring, said first leg being connected to said first wheel via said first additional spring and said first actuator;
a second additional spring surrounding said second actuator such that at least a portion of said second actuator is located within said second additional spring, said second leg being connected to said second wheel via said second additional spring and said second actuator; and
a control means for switching said first actuator and said second actuator from a blocked state to an unblocked state such that said first additional spring and said second additional spring are not actuated when said first actuator and said second actuator are in said blocked state, said first additional spring and said second additional spring being actuated when said first actuator and said second actuator are in said unblocked state.

28. A vehicle in accordance with claim 27, wherein said first leg is movable relative to said first wheel when said first actuator is in said unblocked state, said first actuator forming a first rigid connection between said first leg and said first wheel such that said first leg is not movable relative to said first wheel when said first actuator is in said blocked state, said second leg being movable relative to said second wheel when said second actuator is in said unblocked state, said second actuator forming a second rigid connection between said second leg and said second wheel such that said second leg is not movable relative to said second wheel when said second actuator is in said blocked state.
